(19) United States
(12) Patent Application Publication
(10) Pub. No.: US 2018/0031267 A1
(43) Pub. Date: Feb. 1, 2018

(54) SYSTEM AND METHOD FOR DETECTING FLOW RESTRICTIONS ACROSS A COIL OF AN OUTDOOR HEAT EXCHANGER

(71) Applicant: Johnson Controls Technology Company, Milwaukee, WI (US)

(72) Inventors: Shawn A. Hern, Park City, KS (US); Brian D. Rigg, Douglass, KS (US); Theresa N. Gillette, Wichita, KS (US); Jedidiah O. Bentz, Wichita, KS (US); Shaun B. Atchison, Wichita, KS (US); Tyler McCune, El Dorado, KS (US); Aneek M. Noor, Wichita, KS (US); Tom R. Tasker, Andover, KS (US)

(21) Appl. No.: 15/660,790

(22) Filed: Jul. 26, 2017

Related U.S. Application Data
(60) Provisional application No. 62/367,304, filed on Jul. 27, 2016.

(51) Int. Cl. F24F 11/00; G05B 15/02; F25D 21/04

(52) U.S. Cl. CPC F24F 11/0086; F25D 21/04; G05B 15/02; F24F 2011/0089; F25B 2600/21; F24F 2011/0091; F24F 2011/0038; F24F 1/0022

(57) ABSTRACT

A heating, ventilation, and air conditioning (HVAC) system includes an outdoor unit having a heat exchanger. The heat exchanger includes a coil configured to route refrigerant therethrough. The HVAC system also includes a motor configured to drive a fan, a motor controller configured to regulate operation of the motor, and a global controller configured to regulate operation of global aspects of the HVAC system. The HVAC system also includes a power sensor configured to detect a power parameter relating to a power input to the motor controller, a power output from the motor controller, or a power input to the motor, wherein the global controller is configured to receive data indicative of the power parameter from the power sensor, and wherein the global controller is configured to analyze the data indicative of the power parameter to detect a frozen coil condition, a fouled coil condition, or both.

### CROSS REFERENCE TO RELATED APPLICATIONS

This application claims priority from and the benefit of U.S. Provisional Application Ser. No. 62/367,304, filed Jul. 27, 2016, entitled “OD COIL FOULING SENSING METHOD,” the disclosure of which is hereby incorporated by reference in its entirety for all purposes.

### BACKGROUND

The present disclosure relates generally to heating, ventilation, and air conditioning (HVAC) systems, and more particularly to detection of coil conditions on an outdoor unit of the HVAC system.

A wide range of applications exist for HVAC systems. For example, residential, light commercial, commercial, and industrial systems are used to control temperatures and air quality in residences and buildings. Generally, HVAC systems may circulate a fluid, such as a refrigerant, through a closed loop between an evaporator coil where the fluid absorbs heat and a condenser where the fluid releases heat. The fluid flowing within the closed loop is generally formulated to undergo phase changes within the normal operating temperatures and pressures of the system so that quantities of heat can be exchanged by virtue of the latent heat of vaporization of the fluid. A fan may blow air over, or pull air across, the coils of the heat exchanger(s) in order to condition the air.

HVAC systems may include an indoor unit, an outdoor unit, or both. Certain HVAC systems having both an indoor and outdoor unit may operate in several modes, including a heat pump mode. When the HVAC system operates in the heat pump mode, a heat exchanger of the outdoor unit may act as the evaporator. When the environmental temperature is near, at, or below freezing, and while the HVAC system operates in the heat pump mode such that the heat exchanger of the outdoor unit acts as the evaporator, water may condense and/or freeze on a coil of the heat exchanger of the outdoor unit, which lowers activity and efficiency of the HVAC system. Further, the outdoor unit may be susceptible to fouled coils, regardless of the operating mode. For example, dust, pollen, grass, and/or other contaminants surrounding the outdoor unit may blow across the coils. These contaminants may block the air flow across the coils, thereby increasing a pressure drop across the coils, which reduces an efficiency of the HVAC system. Accordingly, detection and, in certain embodiments, mitigation of outdoor coil conditions (e.g., frozen coil and fouled coil) is desired.

### SUMMARY

The present disclosure relates to a heating, ventilation, and air conditioning (HVAC) system. The HVAC system includes an outdoor unit having a heat exchanger. The heat exchanger includes a coil configured to route refrigerant therethrough. The HVAC system also includes a motor configured to drive a fan, a motor controller configured to regulate operation of the motor, and a global controller configured to regulate operation of global aspects of the HVAC system. The HVAC system also includes a power sensor configured to detect a power parameter relating to a power input to the motor controller, a power output from the motor controller, or a power input to the motor, wherein the global controller is configured to receive data indicative of the power parameter from the power sensor, and wherein the global controller is configured to analyze the data indicative of the power parameter to detect a frozen coil condition, a fouled coil condition, or both.

The present disclosure also relates to a method of detecting coil conditions of a heat exchanger of an outdoor unit of an HVAC system. The method includes detecting, via a power sensor, a power parameter of a power input to a motor controller, a power output from the motor controller, or a power input to a fan motor. The method also includes receiving, at a global controller and from the power sensor, data indicative of the power parameter. The method also includes determining, via the global controller, that the power parameter exceeds a threshold power parameter. The method also includes outputting, via the global controller and to an output device, a notification indicating a flow restriction across a coil of the heat exchanger of the outdoor unit.

The present disclosure also relates to an HVAC system including an outdoor unit having a heat exchanger, where the heat exchanger includes a coil configured to receive a refrigerant. The HVAC system also includes a constant RPM motor configured to drive a fan that blows air across, or pulls air across, the coil of the heat exchanger. The HVAC system also includes a control system communicatively coupled with the constant RPM motor and configured to regulate operation of the constant RPM motor. The HVAC system also includes a power sensor configured to detect a power parameter relating to a power input to the control system, a power output from the control system, or a power input to the constant RPM motor, where the control system is configured to receive data indicative of the power parameter from the power sensor, and where the control system is configured to analyze the data indicative of the power parameter to detect a flow restriction across the coil.

### DRAWINGS

FIG. 1 is an illustration of an embodiment of a commercial or industrial HVAC system, in accordance with the present techniques;

FIG. 2 is an illustration of an embodiment of a packaged unit of the HVAC system shown in FIG. 1, in accordance with the present techniques;

FIG. 3 is an illustration of an embodiment of a split system of the HVAC system shown in FIG. 1, in accordance with the present techniques;

FIG. 4 is a schematic diagram of an embodiment of a refrigeration system of the HVAC system shown in FIG. 1, in accordance with the present techniques;

FIG. 5 is a schematic diagram of an embodiment of an air flow system of an outdoor unit, including a coil condition detection sub-system, in accordance with the present techniques; and

FIG. 6 is a process flow diagram illustrating an embodiment of a process of detecting a coil condition of an outdoor unit of an HVAC system, in accordance with the present techniques.

### DETAILED DESCRIPTION

The present disclosure is directed toward heat exchangers of a commercial, industrial, or residential heating, ventilation, air conditioning, and refrigerant system (“HVAC system”). More particularly, the present disclosure is directed toward detection of conditions of a heat exchanger of an outdoor unit in the HVAC system.

For example, HVAC systems in accordance with the present disclosure may include an outdoor unit having a heat exchanger that acts as a condenser when the HVAC system operates in an air conditioning mode, and an evaporator when the HVAC system operates in a heat pump mode. As air is blown or pulled by a fan across the heat exchanger over time, dust, pollen, grass, and other contaminants may gather on and foul a coil of the heat exchanger (i.e., at least partially block air flow passages across the coil). As the coil is fouled, a pressure drop across the coil of the heat exchanger increases. The fan causing the air flow over the coil may be coupled to a constant revolutions-per-minute (RPM) motor, which drives the fan. As the pressure drop increases, a power input to the fan (and, thus, a power output from [and power input to] a component powering the fan, such as a motor controller) may be increased in order to maintain the RPM of the motor, where the power increase reduces an efficiency of the HVAC system. It should be noted that, while constant RPM motors generally included different RPM settings, the constant RPM motor is configured to maintain a desired RPM at any given time. In other words, the RPM set point may be changed based on operating modes and conditions, but during a particular time period (e.g., having a particular operating mode at particular operating conditions), the constant RPM motor is configured to maintain a certain RPM.

In addition to the fouled coil condition described above, the coil of the heat exchanger of the outdoor system may be susceptible to a frozen coil condition when the HVAC operates in the heat pump mode (i.e., such that the heat exchanger of the outdoor unit acts as the evaporator). For example, when the heat exchanger of the outdoor system acts as the evaporator, and when an outdoor temperature proximate the outdoor unit is near, at, or below freezing, water may condense and freeze on the coil of the heat exchanger. Frozen coil conditions restrict an air flow through the coil, thereby increasing a pressure drop across the coil and decreasing an efficiency of the HVAC system (e.g., similar to the fouled coil condition described above). Frozen coil conditions may also impact refrigerant flow through the coil.

In accordance with present techniques, a motor controller may control operation of the constant RPM motor driving the fan. The motor controller is separate from the motor, and in some embodiments the motor controller may be incorporated with a variable speed drive (“VSD”). A power sensor may sample, detect, or otherwise monitor a power input to the VSD and corresponding motor controller (e.g., from line voltage), a power output from the motor controller (e.g., toward the constant RPM motor), or a power input to the constant RPM motor (e.g., from the motor controller). For example, the power sensor may detect a voltage, a current, a resistance, a torque, a frequency, a wattage, or some other power parameter. Further, the power sensor may be integrated with, or disposed on or proximate to, the motor controller and/or the constant RPM motor.

A global controller of the HVAC system (e.g., where the global controller regulates operation of several or all the HVAC components) may receive sensor feedback from the power sensor. After analyzing the sensor feedback, the global controller or may determine that the power parameter has deviated too far from a set point of the power parameter (e.g., beyond a certain threshold), where the set point of the power parameter corresponds with the aforementioned desired RPM of the constant RPM motor during normal operating conditions in which the coil is not substantially fouled or frozen. The power parameter exceeding the threshold (e.g., where the threshold is set relative to the set point) indicates a flow restriction across the coil. Thus, if the controller determines that the power parameter has exceeded the threshold, the global controller may infer the flow restriction across the coil.

In accordance with the present techniques, an air flow sensor and/or a temperature sensor may be incorporated at, in, or proximate to, the heat exchanger of the outdoor unit. The air flow sensor and the temperature sensor may communicate air flow (e.g., pressure, mass flow rate, etc.) parameters and temperature data, respectively, to the motor controller global controller. Thus, the data from the air flow sensor and/or temperature sensor may be analyzed to differentiate between the fouled coil condition and the frozen coil condition, respectively. The global controller may trigger a fouled coil mitigation mode or a frozen coil mitigation mode in response to the differentiation therebetween. These and other features will be described in detail below with reference to the drawings.

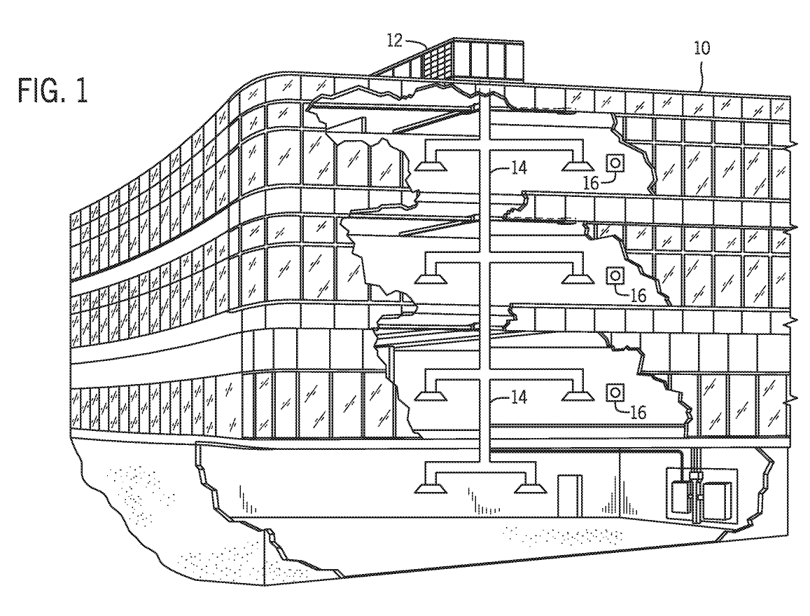

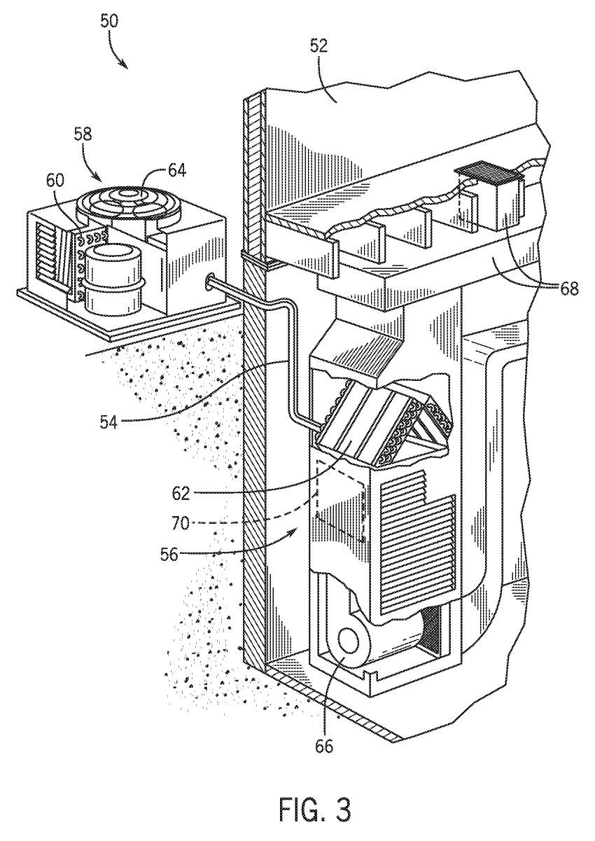

Turning now to the drawings, FIG. 1 illustrates a heating, ventilating, and air conditioning (HVAC) system for building environmental management that may employ one or more HVAC units. In the illustrated embodiment, a building 10 is air conditioned by a system that includes an HVAC unit 12. The building 10 may be a commercial structure or a residential structure. As shown, the HVAC unit 12 is disposed on the roof of the building 10; however, the HVAC unit 12 may be located in other equipment rooms or areas adjacent the building 10. The HVAC unit 12 may be a single package unit containing other equipment, such as a blower, integrated air handler, and/or auxiliary heating unit. In other embodiments, the HVAC unit 12 may be part of a split HVAC system, such as the system shown in FIG. 3, which includes an outdoor HVAC unit 58 and an indoor HVAC unit 56.

The HVAC unit 12 is an air cooled device that implements a refrigeration cycle to provide conditioned air to the building 10. Specifically, the HVAC unit 12 may include one or more heat exchangers across which an air flow is passed to condition the air flow before the air flow is supplied to the building. In the illustrated embodiment, the HVAC unit 12 is a rooftop unit (RTU) that conditions a supply air stream, such as environmental air and/or a return air flow from the building 10. After the HVAC unit 12 conditions the air, the air is supplied to the building 10 via ductwork 14 extending throughout the building 10 from the HVAC unit 12. For example, the ductwork 14 may extend to various individual floors or other sections of the building 10. In certain embodiments, the HVAC unit 12 may be a heat pump that provides both heating and cooling to the building with one refrigeration circuit configured to operate in different modes. In other embodiments, the HVAC unit 12 may include one or more refrigeration circuits for cooling an air stream and a furnace for heating the air stream.

A control device 16, one type of which may be a thermostat, may be used to designate the temperature of the conditioned air. The control device 16 also may be used to control the flow of air through the ductwork 14. For example, the control device 16 may be used to regulate operation of one or more components of the HVAC unit 12 or other components, such as dampers and fans, within the building 10 that may control flow of air through and/or from the ductwork 14. In some embodiments, other devices may be included in the system, such as pressure and/or temperature transducers or switches that sense the temperatures and pressures of the supply air, return air, and so forth. Moreover, the control device 16 may include computer systems that are integrated with or separate from other building control or monitoring systems, and even systems that are remote from the building 10.

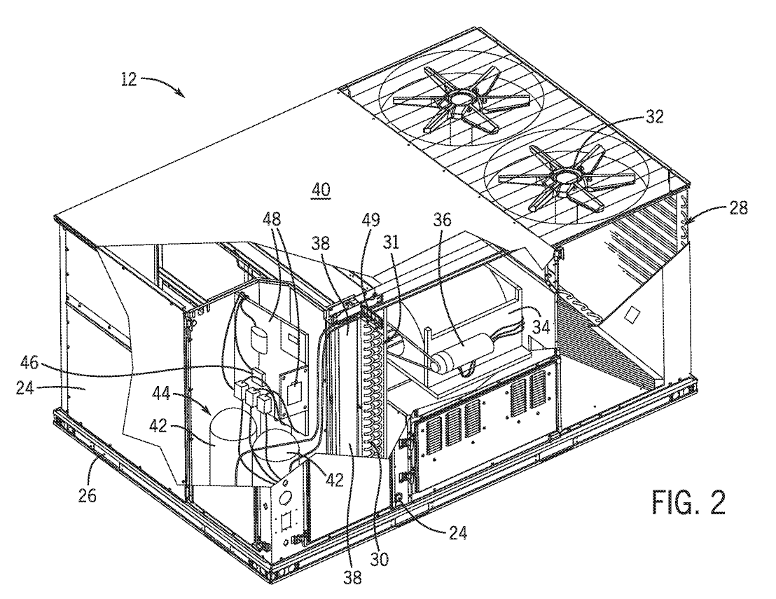

FIG. 2 is a perspective view of an embodiment of the HVAC unit 12. In the illustrated embodiment, the HVAC unit 12 is a single package unit that may include one or more independent refrigeration circuits and components that are tested, charged, wired, piped, and ready for installation. The HVAC unit 12 may provide a variety of heating and/or cooling functions, such as cooling only, heating only, cooling with electric heat, cooling with dehumidification, cooling with gas heat, or cooling with a heat pump. As described above, the HVAC unit 12 may directly cool and/or heat an air stream provided to the building 10 to condition a space in the building 10.

As shown in the illustrated embodiment of FIG. 2, a cabinet 24 encloses the HVAC unit 12 and provides structural support and protection to the internal components from environmental and other contaminants. In some embodiments, the cabinet 24 may be constructed of galvanized steel and insulated with aluminum foil faced insulation. Rails 26 may be joined to the bottom perimeter of the cabinet 24 and provide a foundation for the HVAC unit 12. In certain embodiments, the rails 26 may provide access for a forklift and/or overhead rigging to facilitate installation and/or removal of the HVAC unit 12. In some embodiments, the rails 26 may fit into “curbs” on the roof to enable the HVAC unit 12 to provide air to the ductwork 14 from the bottom of the HVAC unit 12 while blocking elements such as rain from leaking into the building 10.

The HVAC unit 12 includes heat exchangers 28 and 30 in fluid communication with one or more refrigeration circuits. Tubes within the heat exchangers 28 and 30 may circulate refrigerant (for example, R-410A, steam, or water) through the heat exchangers 28 and 30. The tubes may be of various types, such as multichannel tubes, conventional copper or aluminum tubing, and so forth. Together, the heat exchangers 28 and 30 may implement a thermal cycle in which the refrigerant undergoes phase changes and/or temperature changes as it flows through the heat exchangers 28 and 30 to produce heated and/or cooled air. For example, the heat exchanger 28 may function as a condenser where heat is released from the refrigerant to ambient air, and the heat exchanger 30 may function as an evaporator where the refrigerant absorbs heat to cool an air stream. In other embodiments, the HVAC unit 12 may operate in a heat pump mode where the roles of the heat exchangers 28 and 30 may be reversed. That is, the heat exchanger 28 may function as an evaporator and the heat exchanger 30 may function as a condenser. In further embodiments, the HVAC unit 12 may include a furnace for heating the air stream that is supplied to the building 10. While the illustrated embodiment of FIG. 2 shows the HVAC unit 12 having two of the heat exchangers 28 and 30, in other embodiments, the HVAC unit 12 may include one heat exchanger or more than two heat exchangers.

The heat exchanger 30 is located within a compartment 31 that separates the heat exchanger 30 from the heat exchanger 28. Fans 32 draw air from the environment through the heat exchanger 28. Air may be heated and/or cooled as the air flows through the heat exchanger 28 before being released back to the environment surrounding the rooftop unit 12. A blower assembly 34, powered by a motor 36, draws air through the heat exchanger 30 to heat or cool the air. The heated or cooled air may be directed to the building 10 by the ductwork 14, which may be connected to the HVAC unit 12. Before flowing through the heat exchanger 30, the conditioned air flows through one or more filters 38 that may remove particulates and contaminants from the air. In certain embodiments, the filters 38 may be disposed on the air intake side of the heat exchanger 30 to prevent contaminants from contacting the heat exchanger 30.

The HVAC unit 12 also may include other equipment for implementing the thermal cycle. Compressors 42 increase the pressure and temperature of the refrigerant before the refrigerant enters the heat exchanger 28. The compressors 42 may be any suitable type of compressors, such as scroll compressors, rotary compressors, screw compressors, or reciprocating compressors. In some embodiments, the compressors 42 may include a pair of hermetic direct drive compressors arranged in a dual stage configuration 44. However, in other embodiments, any number of the compressors 42 may be provided to achieve various stages of heating and/or cooling. As may be appreciated, additional equipment and devices may be included in the HVAC unit 12, such as a solid-core filter drier, a drain pan, a disconnect switch, an economizer, pressure switches, phase monitors, and humidity sensors, among other things.

The HVAC unit 12 may receive power through a terminal block 46. For example, a high voltage power source may be connected to the terminal block 46 to power the equipment. The operation of the HVAC unit 12 may be governed or regulated by a control board 48. The control board 48 may include control circuitry connected to a thermostat, sensors, and alarms (one or more being referred to herein separately or collectively as the control device 16). The control circuitry may be configured to control operation of the equipment, provide alarms, and monitor safety switches. Wiring 49 may connect the control board 48 and the terminal block 46 to the equipment of the HVAC unit 12.

FIG. 3 illustrates a residential heating and cooling system 50, also in accordance with present techniques. The residential heating and cooling system 50 may provide heated and cooled air to a residential structure, as well as provide outside air for ventilation and provide improved indoor air quality (IAQ) through devices such as ultraviolet lights and air filters. In the illustrated embodiment, the residential heating and cooling system 50 is a split HVAC system. In general, a residence 52 conditioned by a split HVAC system may include refrigerant conduits 54 that operatively couple the indoor unit 56 to the outdoor unit 58. The indoor unit 56 may be positioned in a utility room, an attic, a basement, and so forth. The outdoor unit 58 is typically situated adjacent to a side of residence 52 and is covered by a shroud to protect the system components and to prevent leaves and other debris or contaminants from entering the unit. The refrigerant conduits 54 transfer refrigerant between the indoor unit 56 and the outdoor unit 58, typically transferring primarily liquid refrigerant in one direction and primarily vaporized refrigerant in an opposite direction.

When the system shown in FIG. 3 is operating as an air conditioner, a heat exchanger 60 in the outdoor unit 58 serves as a condenser for re-condensing vaporized refrigerant flowing from the indoor unit 56 to the outdoor unit 58 via one of the refrigerant conduits 54. In these applications, a heat exchanger 62 of the indoor unit functions as an evaporator. Specifically, the heat exchanger 62 receives liquid refrigerant (which may be expanded by an expansion device, not shown) and evaporates the refrigerant before returning it to the outdoor unit 58.

The outdoor unit 58 draws environmental air through the heat exchanger 60 using a fan 64 and expels the air above the outdoor unit 58. When operating as an air conditioner, the air is heated by the heat exchanger 60 within the outdoor unit 58 and exits the unit at a temperature higher than it entered. The indoor unit 56 includes a blower or fan 66 that directs air through or across the indoor heat exchanger 62, where the air is cooled when the system is operating in air conditioning mode. Thereafter, the air is passed through ductwork 68 that directs the air to the residence 52. The overall system operates to maintain a desired temperature as set by a system controller. When the temperature sensed inside the residence 52 is higher than the set point on the thermostat (plus a small amount), the residential heating and cooling system 50 may become operative to refrigerate additional air for circulation through the residence 52. When the temperature reaches the set point (minus a small amount), the residential heating and cooling system 50 may stop the refrigeration cycle temporarily.

The residential heating and cooling system 50 may also operate as a heat pump. When operating as a heat pump, the roles of heat exchangers 60 and 62 are reversed. That is, the heat exchanger 60 of the outdoor unit 58 will serve as an evaporator to evaporate refrigerant and thereby cool air entering the outdoor unit 58 as the air passes over outdoor the heat exchanger 60. The indoor heat exchanger 62 will receive a stream of air blown over it and will heat the air by condensing the refrigerant.

In some embodiments, the indoor unit 56 may include a furnace system 70. For example, the indoor unit 56 may include the furnace system 70 when the residential heating and cooling system 50 is not configured to operate as a heat pump. The furnace system 70 may include a burner assembly and heat exchanger, among other components, inside the indoor unit 56. Fuel is provided to the burner assembly of the furnace 70 where it is mixed with air and combusted to form combustion products. The combustion products may pass through tubes or piping in a heat exchanger (that is, separate from heat exchanger 62), such that air directed by the blower 66 passes over the tubes or pipes and extracts heat from the combustion products. The heated air may then be routed from the furnace system 70 to the ductwork 68 for heating the residence 52.

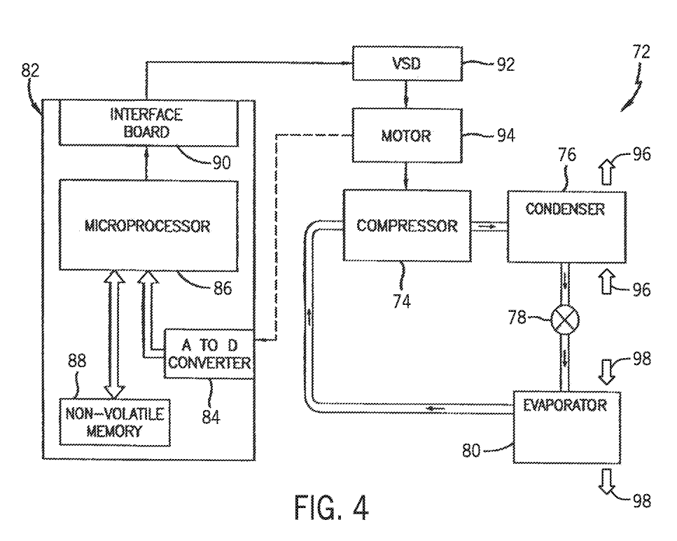

FIG. 4 is an embodiment of a vapor compression system 72 that can be used in any of the systems described above. The vapor compression system 72 may circulate a refrigerant through a circuit starting with a compressor 74. The circuit may also include a condenser 76, an expansion valve(s) or device(s) 78, and an evaporator 80. The vapor compression system 72 may further include a control panel 82 that has an analog to digital (A/D) converter 84, a microprocessor 86, a non-volatile memory 88, and/or an interface board 90. The control panel 82 and its components may function to regulate operation of the vapor compression system 72 based on feedback from an operator, from sensors of the vapor compression system 72 that detect operating conditions, and so forth.

In some embodiments, the vapor compression system 72 may use one or more of a variable speed drive (VSDs) 92, a motor 94, the compressor 74, the condenser 76, the expansion valve or device 78, and/or the evaporator 80. The motor 94 may drive the compressor 74 and may be powered by the variable speed drive (VSD) 92. The VSD 92 receives alternating current (AC) power having a particular fixed line voltage and fixed line frequency from an AC power source, and provides power having a variable voltage and frequency to the motor 94. In other embodiments, the motor 94 may be powered directly from an AC or direct current (DC) power source. The motor 94 may include any type of electric motor that can be powered by a VSD or directly from an AC or DC power source, such as a switched reluctance motor, an induction motor, an electronically commutated permanent magnet motor, or another suitable motor.

The compressor 74 compresses a refrigerant vapor and delivers the vapor to the condenser 76 through a discharge passage. In some embodiments, the compressor 74 may be a centrifugal compressor. The refrigerant vapor delivered by the compressor 74 to the condenser 76 may transfer heat to a fluid passing across the condenser 76, such as ambient or environmental air 96. The refrigerant vapor may condense to a refrigerant liquid in the condenser 76 as a result of thermal heat transfer with the environmental air 96. The liquid refrigerant from the condenser 76 may flow through the expansion device 78 to the evaporator 80.

The liquid refrigerant delivered to the evaporator 80 may absorb heat from another air stream, such as a supply air stream 98 provided to the building 10 or the residence 52. For example, the supply air stream 98 may include ambient or environmental air, return air from a building, or a combination of the two. The liquid refrigerant in the evaporator 80 may undergo a phase change from the liquid refrigerant to a refrigerant vapor. In this manner, the evaporator 80 may reduce the temperature of the supply air stream 98 via thermal heat transfer with the refrigerant. Thereafter, the vapor refrigerant exits the evaporator 80 and returns to the compressor 74 by a suction line to complete the cycle.

In some embodiments, the vapor compression system 72 may further include a reheat coil in addition to the evaporator 80. For example, the reheat coil may be positioned downstream of the evaporator relative to the supply air stream 98 and may reheat the supply air stream 98 when the supply air stream 98 is overcooled to remove humidity from the supply air stream 98 before the supply air stream 98 is directed to the building 10 or the residence 52.

It should be appreciated that any of the features described herein may be incorporated with the HVAC unit 12, the residential heating and cooling system 50, or other HVAC systems. Additionally, while the features disclosed herein are described in the context of embodiments that directly heat and cool a supply air stream provided to a building or other load, embodiments of the present disclosure may be applicable to other HVAC systems as well. For example, the features described herein may be applied to mechanical cooling systems, free cooling systems, chiller systems, or other heat pump or refrigeration applications.

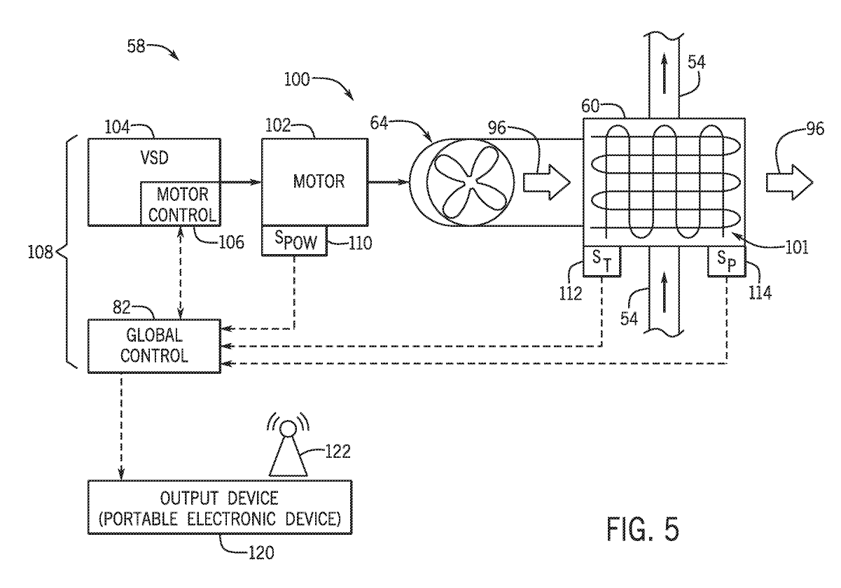

Further, in accordance with present techniques, an outdoor air flow restriction detection system, which determines air flow restriction across a heat exchanger of an outdoor unit by analyzing a power input to a fan motor (or power output from a controller powering the fan motor, or power input to the motor controller powering the fan [e.g., from line voltage]), may be incorporated in any of the systems illustrated in FIGS. 1-4. The outdoor air flow restriction detection system will be described in detail below with reference to FIGS. 5-7.

FIG. 5 is a schematic diagram of an embodiment of an air flow system 100 of an outdoor unit 58, including a coil condition detection sub-system, in accordance with the present techniques. As described with respect to previous drawings, the outdoor unit 58 may include, as shown in the illustrated embodiment, the heat exchanger 60 and the fan 64. The fan 64 in the illustrated embodiment blows the environmental air 96 across a coil 101 of the heat exchanger 60. In other embodiments, the fan 64 may instead pull the environmental air 96 across the coil 101 of the heat exchanger 60 toward the fan 64. The refrigerant conduits 54 may route refrigerant to, and from, the heat exchanger 60 of the outdoor unit 58. As previously described, the heat exchanger 60 may act as a condenser during an air conditioning mode. The heat exchanger 60 may act as an evaporator during a heat pump mode.

The air flow system 100 also includes a fan motor 102, a VSD 104 separate from the fan motor 102, a dedicated motor controller 106 integrated with the VSD 104, and the previously described controller 82 (e.g., global controller). The global controller 82 is configured to regulate operation of several aspects (e.g., global aspects) of the HVAC system, as will be appreciated in view of the description below, while the motor controller 106 is configured to operate to control (and power) the fan motor 102. The global controller 82 and the motor controller 106 form at least a portion of a control system 108 of the HVAC system.

The air flow system 100 in the illustrated embodiment also includes a power sensor 110 configured to detect a power parameter (e.g., voltage, current, resistance, or torque, frequency, wattage) of the power output from (or power input to) the motor controller 106 or a power input to the motor 102. In the illustrated embodiment, the power sensor 110 operates to detect a power parameter of the power input to the motor 102. However, the power sensor 110 may, in another embodiment, be disposed at or proximate to (or within an internal circuitry of) the motor controller 106, such that the power sensor 110 detects a power parameter of the power output from (or power input to) the motor controller 106. In some embodiments, the power sensor 110 may detect a power input to the motor controller 106, or more generally a power input to the VSD 104 having the motor controller 106 (e.g., where the motor controller 106 utilizes the power input to the VSD 104 to power the motor 102).

The fan motor 102 in the illustrated embodiment is a constant revolutions-per-minute (RPM) motor. Thus, the fan motor 102 maintains a desired RPM that corresponds with an operating mode of the outdoor unit 58 and operating conditions surrounding the outdoor unit 58. In other words, the desired RPM corresponds with normal operating conditions. It should be noted that the desired RPM may change with the desired operating mode, but that for a given operating mode, a desired RPM is maintained by the constant RPM motor 102.

As the fan 64 blows or pulls the environmental air 96 across the coil 101 of the heat exchanger 60 over time, contaminants (e.g., dust, pollen, grass, dirt, etc.) may foul the coil 101 of the heat exchanger 60. As the coil 101 is fouled, a pressure drop across the coil 101 increases.

Further, when the HVAC system operates in a heat pump mode such that the heat exchanger 60 operates as the evaporator of the HVAC system, the coil 101 may condense water thereon if the outdoor temperature is near, at, or below freezing. As the water condenses and at least partially freezes on the coil 101, a pressure drop across the coil 101 increases (and, in some embodiments, movement of the refrigerant through the refrigerant conduits 54 and the coil 101 is impacted).

As the pressure drop across the coil 101 increases due to the frozen coil condition and/or the fouled coil condition described above, the motor 102 may increase its power input in order to maintain the previously described desired RPM. In other words, as the pressure drop across the coil 101 increases, a back pressure on the fan 64 may cause the motor 102 to draw more power from the motor controller 106 in order to maintain the desired RPM corresponding with the operating mode and normal operating conditions. The power sensor 110 detects (e.g., samples) a power parameter corresponding with the power input to the constant RPM fan motor 102 (or power input to or output from the motor controller 106), and conveys data indicative of the power parameter to the global controller 82. The global controller 82 may compare the data received from the power sensor 110 with a set point of the power parameter, where the set point corresponds with an amount of power needed to achieve the aforementioned desired RPM of the motor 102 during normal operating conditions. In particular, the global controller 82 may detect a flow restriction condition if the power parameter exceeds a power threshold limit. In some embodiments, the power threshold limit may be a percentage of the set point (e.g., if the threshold limit is 125% of the set point, the flow restriction condition is determined when the detected power parameter is 125% of the set point).

In some embodiments, analysis of the power parameter over time may be adequate to differentiate between a frozen coil condition and a fouled coil condition, both of which being encompassed by the aforementioned flow restriction condition. For example, if the power parameter changes rapidly or within a particular time period following activation of the heat pump mode of the HVAC system, the frozen coil condition may be determined by the global controller 82. Further, if the global controller 82 is equipped with a digital clock having date stamp features, the global controller 82 may infer either the frozen coil condition or the fouled coil condition on the basis of time-related information, such as time of day, season, etc.

In some embodiments, additional sensor feedback may be utilized to differentiate between the frozen coil condition and the fouled coil condition. Differentiating between the two may be advantageous because mitigation techniques of the frozen coil condition may differ from mitigation techniques of the fouled coil condition, as will be appreciated in view of the description below. In the illustrated embodiment, the outdoor unit 58 may be optionally equipped with a temperature sensor 112 disposed at, in, or proximate to the heat exchanger 60, and/or an air flow sensor 114 (or series of air flow sensors) disposed at, in, or proximate to the heat exchanger 60. The temperature sensor 112 may be configured to detect a temperature of the coil 101 of the heat exchanger 60, and may communicate data indicative of the temperature to the global controller 82. The air flow sensor 114 (or series of air flow sensors) may be configured to detect an air flow parameter (e.g., pressure, mass flow rate, etc.) adjacent the coil 101, and may communicate data indicative of the air flow parameter to the global controller 82. However, other types of sensors may also be used to diagnose flow restriction conditions (e.g., to determine the frozen coil or fouled coil condition). For example, a refrigerant pressure transducer may be utilized, a photo-optic sensor may be utilized, and/or other sensors may be utilized to facilitate diagnosis of certain flow restriction conditions.

The global controller 82 may analyze the temperature data, the air flow data, or both to determine whether the flow restriction is caused by the frozen coil condition or the fouled coil condition. For example, if the global controller 82 determines that the temperature data is lower than a threshold temperature, the global controller 82 may determine the frozen coil condition. If the global controller 82 determines that the temperature data is higher than the threshold temperature, the global controller 82 may exclude a possibility the frozen coil condition, and determine the fouled coil condition. In some embodiments, the global controller 82 may consider two threshold temperatures, namely, an upper threshold temperature and a lower threshold temperature that is less than the upper threshold temperature. If the detected temperature exceeds the upper threshold temperature, the global controller 82 may determine the fouled coil condition. If the detected temperature is less than the lower threshold temperature, the global controller 82 may determine the frozen coil condition. If the detected temperature is between the upper threshold temperature and the lower threshold temperature, the global controller 82 may consider additional sensor feedback of non-temperature related parameters to determine either the frozen coil condition or the fouled coil condition (or, alternatively, communicate a notification to an output device 120 indicating a general flow restriction condition).

In some embodiments, analysis of air flow data may enable the global controller 82 to differentiate between the frozen coil condition and the fouled coil condition. For example, in some embodiments, the air flow sensor 114 may correspond with a series of air flow sensors that sample air flow data at various points across the coil 101. By analyzing data from the series of air flow sensors with respect to the locations of the corresponding sensors, the global controller 82 may determine whether the flow restriction is caused by the frozen coil condition or the fouled coil condition.

The global controller 82 may communicate a notification to an output device 120 (e.g., output interface on the HVAC system, a portable electronic device, a thermostat, etc.) upon determining a flow restriction condition. For example, in some embodiments, the global controller 82 may be communicatively coupled with a network 122 (e.g., the Internet), which enables communication with the output device 120 (e.g., in embodiments where the output device 120 is remote to the HVAC system). The notification may indicate generally a flow restriction condition, or the notification may indicate specifically a flow restriction condition caused by either the frozen coil condition or the fouled coil condition.

Additionally, in some embodiments, the global controller 82 may operate, in response to determining the specific cause (e.g., frozen coil or fouled coil) of the flow restriction, to mitigate the specific cause (e.g., frozen coil or fouled coil). For example, the global controller 82 may instruct a defrost mode in which flow of the refrigerant through the refrigerant conduit 54 and the coil 101 is reversed, thereby at least temporarily ending the heat pump mode, in response to detecting the frozen coil condition. In doing so, the global controller 82 may cause the refrigerant to thaw the frozen coil condition. Alternatively, if the global controller 82 determines the fouled coil condition, the global controller 82 may instruct a blow-out mode, in which the fan 64 is controlled to reverse flow direction (e.g., such that the environmental air 96 is pulled toward the fan 64 in the illustrated embodiment). It should be noted that, in embodiments where the fan 64 is configured to pull the environmental air 96 through the heat exchanger 60 and toward the fan 64 in normal operating modes, the blow-out mode would involve reversing the flow direction of the fan 64 such that the environmental air 96 is blown by the fan 64 toward the heat exchanger 60 in the blow-out mode.

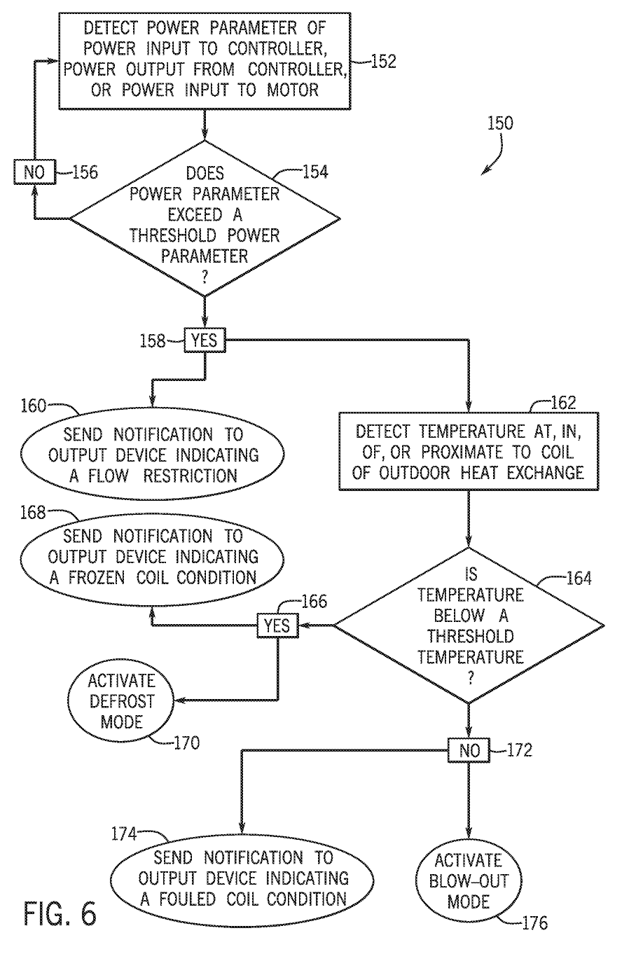

FIG. 6 is a process flow diagram illustrating an embodiment of a process 150 of detecting a coil condition of a heat exchanger of an outdoor unit of an HVAC system, in accordance with the present techniques. The process 150 includes detecting (block 152) a power parameter of a power input to a fan motor of the HVAC system, or of a power output from a motor controller toward the fan motor (or, in some embodiments, a power input to the motor controller [e.g., from line voltage]). For example, line voltage may power a motor controller, the motor controller may power the motor, and a power sensor at, on, or proximate to the motor controller or the motor may detect the various power inputs/outputs.

The process 150 also includes comparing (block 154) the power parameter with a threshold. For example, a global controller may receive the power parameter detected by the power sensor, and compare the power parameter against the threshold power parameter. If the detected power parameter does not exceed the threshold (block 156), no flow restriction condition is detected and the process begins again at the power parameter detection step (block 152). If the power parameter exceeds the threshold (block 158), a flow restriction condition may be detected.

As previously described, the global controller may send (block 160) a notification to an output device indicating the general flow restriction condition (e.g., in response to determining the flow restriction condition). As previously described, in some embodiments, the global controller may determine that the flow restriction condition is either a frozen coil condition or a fouled coil condition without additional feedback. For example, the global controller may infer the fouled coil condition or the frozen coil condition by analyzing time/date related information (e.g., seasonal information, time of day information, etc.). In such embodiments, the global controller may send the notification indicating the specific type of flow restriction condition (i.e., fouled coil condition or frozen coil condition).

In other embodiments, additional sensor feedback may be considered to determine either the fouled coil condition or the frozen coil condition. For example, the illustrated process 150 also includes detecting (block 162) a temperature at, in, of, or proximate to the coil of the outdoor heat exchanger. The temperature then may be compared, by the global controller, with a threshold temperature. If the detected temperature is lower than the threshold temperature (block 166), the global controller determines the frozen coil condition and sends (block 168) a notification to the output device indicating the frozen coil condition. In the illustrated embodiment, the global controller also activates (block 170) a defrost mode (e.g., by discontinuing a heat pump mode and/or reversing flow of the refrigerant through the HVAC system).

If the detected temperature is not lower than the threshold temperature (block 172), the global controller may exclude the possibility of the frozen coil condition and, instead, determine the fouled coil condition. Thus, the global controller may send (block 174) a notification to the output device indicating the fouled coil condition. In the illustrated embodiment, the global controller also activates (block 176) a blow-out mode (e.g., by instructing the fan to reverse direction of an air flow therethrough.

It should be noted that, in another embodiment, the detected temperature may be compared with two separate temperature thresholds. For example, if the detected temperature is higher than an upper temperature threshold, the global controller may determine the fouled coil condition. If the detected temperature is under a lower temperature threshold, the global controller may determine the frozen coil condition. If the detected temperature is between the upper temperature threshold and the lower temperature threshold, the global controller may utilize other sensor feedback (e.g., air flow sensor feedback, as previously described) to determine a source of the flow restriction, or the global controller may only communicate to the output device the notification indicating the general flow restriction.

One or more of the disclosed embodiments, alone or in combination, may enable detection of flow restrictions across a coil of a heat exchanger in an outdoor unit of an HVAC system via analysis of changes in a power input to a fan motor blowing/pulling air over the coil, or via analysis of changes in a power output from (or power input to) a controller powering the fan motor. In some embodiments, fouled coil conditions and/or frozen coil conditions may be determined only through analysis of power parameters relating to the aforementioned power input to the fan motor or power output from (or input to) the controller. Presently disclosed techniques reduce processing power for determining flow restrictions across the coil, and improve user accessibility to flow restriction information.

While only certain features and embodiments of the present disclosure have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the disclosure. Furthermore, in an effort to provide a concise description of the exemplary embodiments, all features of an actual implementation may not have been described (i.e., those unrelated to the presently contemplated best mode of carrying out an embodiment, or those unrelated to enabling the claimed embodiments). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1. A heating, ventilation, and air conditioning (HVAC) system, comprising:
an outdoor unit comprising a heat exchanger, wherein the heat exchanger comprises a coil configured to route refrigerant therethrough;
a motor configured to drive a fan;
a motor controller configured to regulate operation of the motor;
a global controller configured to regulate operation of global aspects of the HVAC system; and
a power sensor configured to detect a power parameter relating to a power input to the motor controller, a power output from the motor controller, or a power input to the motor, wherein the global controller is configured to receive data indicative of the power parameter from the power sensor, and wherein the global controller is configured to analyze the data indicative of the power parameter to detect a flow restriction corresponding with a frozen coil condition, a fouled coil condition, or both.

2. The HVAC system of claim 1, wherein the motor is a constant revolutions-per-minute (RPM) motor.

3. The HVAC system of claim 1, comprising a temperature sensor positioned at or proximate to the heat exchanger and configured to detect a temperature of the heat exchanger, wherein the global controller is configured to receive data indicative of the temperature of the heat exchanger from the temperature sensor, and wherein the global controller is configured to analyze the data indicative of the temperature of the heat exchanger to determine or exclude a possibility of the frozen coil condition.

4. The HVAC system of claim 3, wherein the global controller is configured to:
determine the frozen coil condition;
instruct a reversal of a flow of refrigerant through the HVAC system in response to detecting the frozen coil condition, thereby activating a defrost mode; and/or
communicate a notification to an output device, wherein the notification indicates the frozen coil condition.

5. The HVAC system of claim 3, wherein the global controller is configured to:
exclude a possibility the frozen coil condition and determine the fouled coil condition;
activate a blow-out mode to mitigate the fouled coil condition; and/or
communicate a notification to an output device, wherein the notification indicates the fouled coil condition.

6. The HVAC system of claim 1, comprising a variable speed drive (VSD) separate from the motor, wherein the motor controller is integral with the VSD.

7. The HVAC system of claim 1, wherein the global controller is configured to detect the frozen coil condition, the fouled coil condition, or both by determining that the power parameter exceeds a threshold power parameter.

8. The HVAC system of claim 7, wherein the motor comprises a constant RPM motor, and wherein the threshold power parameter is variable and indicative of a desired RPM of the constant RPM motor at a given point in time.

9. The HVAC system of claim 1, wherein the power parameter comprises a voltage, an electric current, a resistance, a torque, a frequency, or a wattage.

10. The HVAC system of claim 1, wherein the global controller is configured to communicate a notification to an output device indicative of the flow restriction.

11. The HVAC system of claim 10, wherein the output device is a portable electronic device, a thermostat, or an output screen of the HVAC system.

12. The HVAC system of claim 1, wherein the heat exchanger is configured to operate as an evaporator during a heat pump mode of the HVAC system

13. A method of detecting coil conditions of a heat exchanger of an outdoor unit of an HVAC system, wherein the method comprises:
detecting, via a power sensor, a power parameter of a power input to a motor controller, a power output from the motor controller, or a power input to a fan motor;
receiving, at a global controller and from the power sensor, data indicative of the power parameter;
determining, via the global controller, that the power parameter exceeds a threshold power parameter;
outputting, via the global controller and to an output device, a notification indicating a flow restriction across a coil of the heat exchanger of the outdoor unit.

14. The method of claim 13, comprising:
detecting, via a temperature sensor, a temperature of the heat exchanger;
receiving, at the global controller and from the temperature sensor, data indicative of the temperature of the heat exchanger; and
determining, via the global controller and based on an analysis of the data indicative of the temperature of the heat exchanger, that the flow restriction across the coil is caused by a frozen coil condition.

15. The method of claim 14, comprising instructing, via the global controller, a reversal of a flow of refrigerant through the HVAC system in response to detecting the frozen coil condition, thereby activating a defrost mode.

16. The method of claim 13, comprising:
detecting, via a temperature sensor, a temperature of the heat exchanger;
receiving, at the global controller and from the temperature sensor, data indicative of the temperature of the heat exchanger; and
determining, via the global controller and based on an analysis of the data indicative of the temperature of the heat exchanger, that the flow restriction across the coil is caused by a fouled coil condition.

17. The method of claim 16, comprising instructing, via the global controller, a blow-out mode to mitigate the fouled coil condition.

18. The method of claim 13, wherein the motor controller is integrated with a VSD, and wherein the VSD is separate from the fan motor.

19. An HVAC system, comprising:
an outdoor unit comprising a heat exchanger, wherein the heat exchanger comprises a coil configured to receive a refrigerant;
a constant RPM motor configured to drive a fan that biases air across the coil of the heat exchanger;
a control system communicatively coupled with the constant RPM motor and configured to regulate operation of the constant RPM motor; and
a power sensor configured to detect a power parameter relating to a power input to the control system, a power output from the control system, or a power input to the constant RPM motor, wherein the control system is configured to receive data indicative of the power parameter from the power sensor, and wherein the control system is configured to analyze the data indicative of the power parameter to detect a flow restriction across the coil.

20. The HVAC system of claim 19, wherein the control system comprises:
a motor controller configured to regulate operation of the constant RPM motor, wherein the power sensor is configured to detect the power parameter relating to the power input to the motor controller, the power output from the motor controller, or the power input to the constant RPM motor; and
a global controller configured to regulate global aspects of the HVAC system, wherein the global controller is configured to receive the data indicative of the power parameter from the power sensor, and wherein the global controller is configured to analyze the data indicative of the power parameter to detect the flow restriction across the coil.

21. The HVAC system of claim 19, wherein the control system is configured to communicate a notification to an output device, wherein the notification indicates the flow restriction across the coil.

22. The HVAC system of claim 19, comprising a temperature sensor positioned at or proximate to the heat exchanger and configured to detect a temperature of the heat exchanger, wherein the control system is configured to receive data indicative of the temperature of the heat exchanger from the temperature sensor, and wherein the control system is configured to analyze the data indicative of the temperature of the heat exchanger to determine that the flow restriction across the coil is caused by a frozen coil condition.

23. The HVAC system of claim 22, wherein the control system is configured to instruct a reversal of a flow of refrigerant through the HVAC system in response to determining the frozen coil condition, thereby activating a defrost mode.
